(19) United States
(12) Patent Application Publication
(10) Pub. No.: US 2026/0336485 A1
(43) Pub. Date: Oct. 29, 2026

(54) SYSTEMS AND METHODS FOR A CONVERTIBLE CAR SEAT

(71) Applicant: Graco Children's Products Inc., Atlanta, GA (US)

(72) Inventors: Thomas Jake Mitchell, Smyrna, GA (US); Christian Downer, Atlanta, GA (US); Adam Andrew McKenzie, Decatur, GA (US)

(73) Assignee: Graco Children’s Products Inc., Atlanta, GA (US)

(21) Appl. No.: 19/639,964

(22) Filed: Apr. 6, 2026

Related U.S. Application Data
(60) Provisional application No. 63/796,256, filed on Apr. 28, 2025.

(51) Int. Cl. B60N 2/28

(52) U.S. Cl. CPC B60N 2/2893; B60N 2/2821; B60N 2/286; B60N 2/2863

(57) ABSTRACT

A convertible child carrying system is provided. The child carrying system may include a car seat having a base. An anchor member may be pivotably and rotatably mounted to the base. The anchor member may include one or more rigid-LATCH anchors that are configured to attach to corresponding anchors in the vehicle seat. The anchor member may be tethered to the base using one or more cables or ties and be independently movable with respect to the base. In order to change the car seat from a rear-facing configuration to a forward facing configuration, the anchor member may be decoupled from the base, rotated 180 degrees, and then re-coupled to the base. This reverses the position of the rigid-LATCH anchors thereby allowing the car seat to be easily switched between the rear-facing and the forward-facing configurations. In some instances, the rigid-LATCH anchors may be separable from the anchor plate.

### CROSS-REFERENCE TO RELATED APPLICATION

This application claims the benefit of US Application No. 63/796,256, filed Apr. 28, 2025, which is hereby incorporated by reference.

### TECHNICAL FIELD

The present disclosure relates generally to car seats, and more specifically to car seats that can be used both in a rear-facing configuration and a forward-facing configurations.

### BACKGROUND

Conventionally, car seats were designed to be either used only in a rear-facing configuration or only in a forward facing configuration. This required a user to buy two different cars seats as a child grew from an infant to a toddler. In case of users with multiple children with varying ages, the user would have to buy multiple different car seats with little to no interoperability.

There are currently car seats that can be interchangeably used either in the rear-facing or a forward-facing configurations. However, most of these seats use the vehicle seat belt to secure the car seat base to the vehicle seat and may use a rotatable base to rotate the car seat between the rear-facing and the forward-facing positions. In other instances, the entire car seat may need to be detached and re-installed in the desired orientation. These installation methods may be cumbersome and time-consuming.

### BRIEF DESCRIPTION OF THE DRAWINGS

FIGS. 1A-1D illustrate various views of a car seat in accordance with the principles of the present disclosure.

FIGS. 2A-2B illustrate the details of the base and the anchor plate according to the principles of the present disclosure.

FIGS. 3A-3C illustrate the operation of the car seat in accordance with the principles of the present disclosure.

FIGS. 4A-4C illustrate various views of a car seat assembly in accordance with principles of the present disclosure.

FIGS. 5A-5D illustrates the details of the anchor plate and the two anchors of the car seat assembly of FIGS. 4A-4C and in accordance with the principles of the present disclosure.

FIGS. 6A-6C illustrate the operation of the car seat assembly of FIGS. 4A-4C in accordance with the principles of the present disclosure.

FIGS. 7A-7C illustrate various views of yet another car seat assembly in accordance with the principles of the present disclosure.

FIGS. 8A-8D illustrates various views of the car seat base and the anchor base sub-assembly of the car seat assembly of FIGS. 7A-7C in accordance with the principles of the present disclosure.

FIG. 8E illustrates a single anchor assembly of the car seat assembly of FIGS. 7A-7C in accordance with the principles of the present disclosure.

FIGS. 9A and 9B illustrate the front view and bottom views of the anchor base of the car seat assembly of FIGS. 7A-7C in accordance with the principles of the present disclosure.

FIGS. 10A-10C illustrate the operation of the car seat assembly of FIGS. 7A-7C in accordance with the principles of the present disclosure.

FIG. 11 illustrates a flow chart of a process for using a car seat in accordance with the principles of the present disclosure.

The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

The convertible child restraint system described herein advantageously allows a user to easily change the car seat from a rear-facing configuration to a forward-facing configuration and vice versa. The present disclosure includes non-limiting embodiments of the convertible child restraint system that has a rotatable base plate with rigid-LATCH anchors that allow the car seat to be easily moved between a rear-facing configuration and a forward-facing configuration. The embodiments are described in detail herein to enable one of ordinary skill in the art to practice the convertible child restraint system, although it is to be understood that other embodiments may be utilized and that logical changes may be made without departing from the scope of the disclosure. Reference is made herein to the accompanying drawings illustrating some embodiments of the disclosure, in which use of the same reference numerals indicates similar or identical items. Throughout the disclosure, depending on the context, singular and plural terminology may be used interchangeably.

The meanings of the terms used herein will be apparent to one of ordinary skill in the art or will become apparent to one of ordinary skill in the art upon review of the detailed description when taken in conjunction with the several drawings and the appended claims. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art.

Embodiments of the present disclosure provide a car seat that may comprise a car seat shell, a base attached to the car seat shell, and an anchor member coupled to the base. The anchor member may further include one or more anchors. The anchor member may be configured to rotate in response to application of a first force. The anchor member may be further decouplable from the base. The car seat of claim may further include a locking mechanism that couples the anchor member to the base or the car seat shell. The anchor member of the car seat may be further configured to rotate in a clockwise or in an anti-clockwise direction between 180 degrees and 360 degrees. In another instance, the one or more anchors may be configured to rotate along with the anchor member. In yet another instance, the one or more anchors may be detachably coupled to the anchor member. In a specific instance, the one or more anchors may include rigid-LATCH anchors. In another instance, the anchor member may be configured to rotate around a single pivot point and be placed in an extended state. The anchor member may then be rotatable when placed in the extended state.

Other embodiments of the present disclosure provide a car seat system that may include a car seat shell, a base coupled to the car seat shell, and an anchor member coupled to the base. The anchor member may further comprise one or more anchors. Each of the one or more anchors may be coupled to the base. In one instance, each of the one or more anchors is independently rotatable around an axis and the one or more anchors may be configurable to place the car seat system in a rear-facing configuration or a forward-facing configuration. The one or more anchors of the car seat system may further include a first anchor and a second anchor. The first anchor may be configured to rotate around a first vertical axis and the second anchor may configured to rotate around a second vertical axis that is different from the first vertical axis. The anchor member may further include one or more channels, and the one or more anchors may be coupled to a respective channel of the one or more channels. In another embodiment, each of the one or more anchors may reside partially within a corresponding channel of the one or more channels. Each of the one or more anchors of the car seat system may be rotatable by at least 180 degrees. Further, each of the one or more anchors may be coupled to the anchor member at a single pivot point.

In yet another embodiment, a car seat system is provided that may include a car seat shell, an anchor base coupled to the car seat shell, wherein the anchor base includes one or more channels, and one or more anchor members removably coupled to the anchor base. Each of the one or more anchor members may include a rail insert configured to mate with a channel of the one or more channels. The rail insert of the car seat system may be configurable to be inserted into a corresponding channel, of the one or more channels, from a first direction or an opposing second direction. The car seat system may further include a tether attached to each of the one or more anchor members. The tether may be configured to keep the one or more anchor members physically coupled to the anchor base at all times. A portion of each of the one or more anchor members may be extensible and retractable. In an embodiment, The first anchor member of the one or more anchor members may include a first connection point and a second connection point and when the car seat system is in the rear-facing configuration, the first anchor may be coupled to a first channel of the one or more channels, via the first connection point, and when the car seat system is in the forward-facing configuration, the first anchor member may be coupled to the first channel via the second connection point.

The present disclosure provides details on an exemplary convertible child restraint system, but one skilled in the art will realize that other types of convertible child restraint systems may also be manufactured using the systems and methods provided in this disclosure.

As explained above, the use of car seats in vehicles primarily falls under two categories. A car set may be used in a rear-facing configuration or a forward-facing configuration. A rear-facing configuration is often used for toddlers 2 years of age and weighing less than 40 pounds. Some states may have stricter requirements or conditions regarding use of a car seat in a rear-facing configuration. Car seats used in a forward-facing configuration may be used for children between the ages of 2-4 years, depending on their size, and specific car seat limits. In some instances, a forward-facing configuration is recommended until a child reaches a weight of between 40 and 65 pounds. Thereafter, a child may use a booster seat until they are eligible to use the seat belts of the vehicle. Previously, car seats were designed to be either used only in the rear-facing configuration or only the forward-facing configuration. This required a user to buy two different car seats as the child grew from an infant to a toddler. There are car seats in the market today that can be used both in the rear-facing configuration as well as in the forward-facing configuration. However, current systems for converting a car seat from a rear-facing configuration to a forward-facing configuration may be cumbersome and not user-friendly. Embodiments of the present disclosure provide systems and methods for converting a car seat for use between a rear-facing configuration and a forward-facing configuration that are easy to operate and may provide a secure and robust alternative to the current designs on the market.

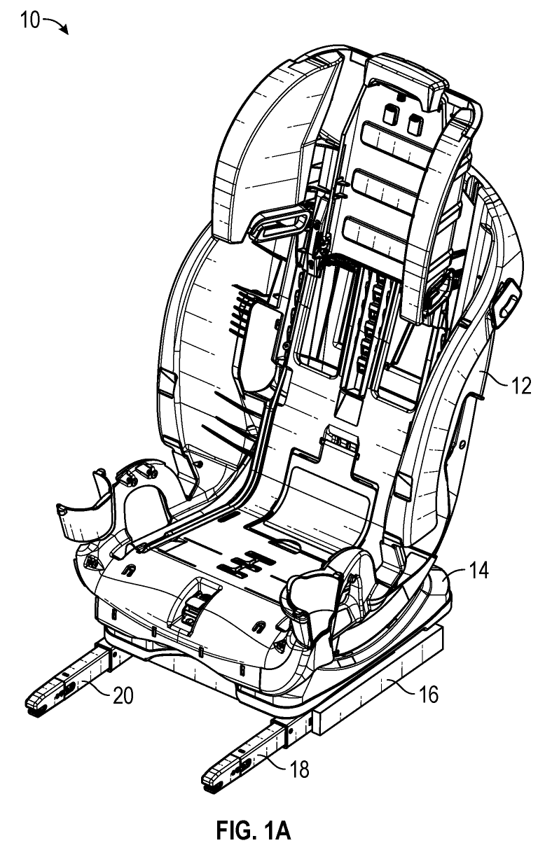

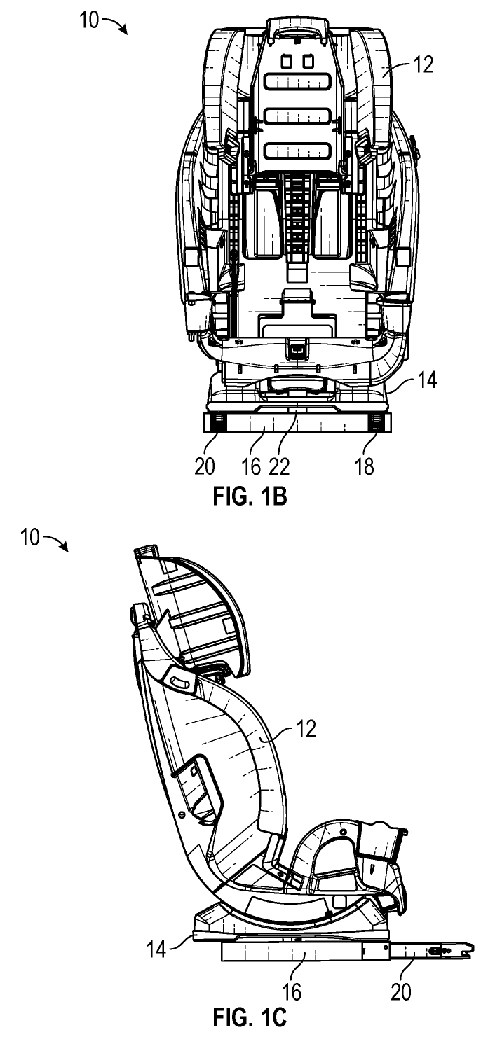

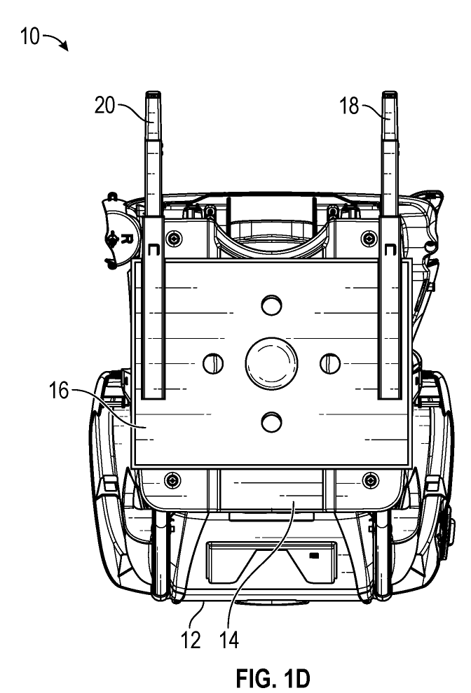

FIGS. 1A-1D illustrate various views of a car seat 10 in accordance with the principles of the present disclosure. The car seat 10 may include a body or a shell 12. In an embodiment, the shell 12 may be manufactured using any known materials and processes known in the art. The shell 12 may have a base 14 coupled to it. In an embodiment, the base 14 may be integrated with the shell 12 so as to form one single unit. In other embodiments, the base 14 may be removably coupled to the shell 12 such that the shell 12 and the base 14 may be separated into individual items and transported separately. In this instance, the base 14 may be coupled with the shell using any quick connect/disconnect mechanism that is approved for use in car seats. A rotatable anchor plate 16 may be coupled to the car seat shell 12 and/or the base 14. The rotatable anchor plate 16 may be manufactured using any known materials and processes known in the art. In an embodiment, the anchor plate 16 may be coupled to the shell 12 and/or the base 14 via a single pivot point described below. The anchor plate 16 may include two or more rigid anchors 18 and 20 that may be used to couple the car seat 10 to corresponding anchor points of a vehicle seat (not shown). In an embodiment, the anchors 18 and 20 may be compliant with a Lower Anchors and Tethers for Children (LATCH) system that is designed to secure the car seat 10 to the vehicle sear without the use of seat belts.

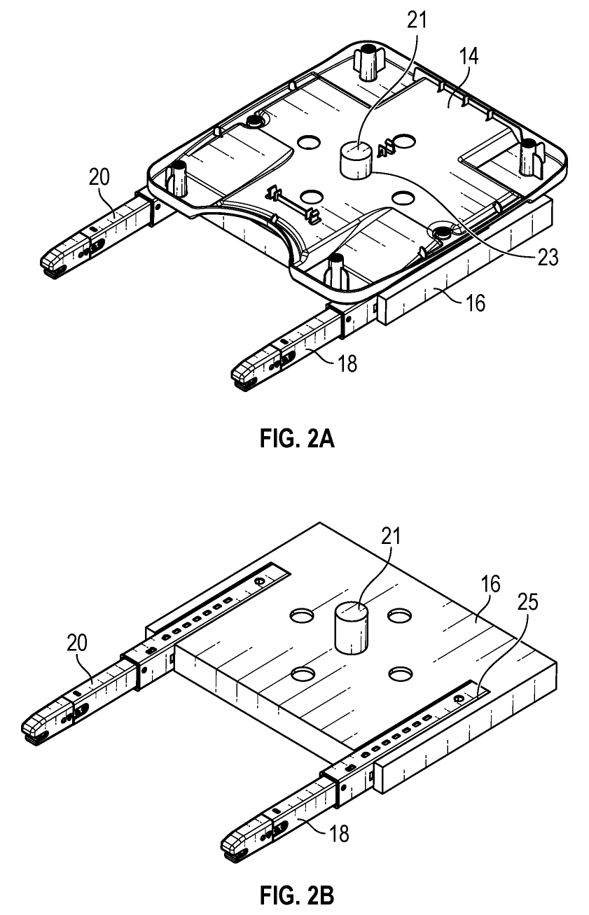

FIGS. 2A-2B illustrate the details of the base 14 and the anchor plate 16 according to the principles of the present disclosure. The base 14 may be connected to the anchor plate 16 using one or fasteners that secure the based 14 to the anchor plate 16. In an embodiment, the base 14 may be rectangular is shape, although the shape of the base 14 is not germane to the disclosure. In other embodiments, the base 14 may be of other shapes such as circular or polygonal. The base 14 may have an opening 23 located at a center of the base 14. The opening 23 may act as a pivot point for the rotation of the anchor plate 16. The anchor plate 16 may have a post 21. The base 14 and the anchor plate 16 are connected such that the post 21 passes through the opening 23 in the base 14 and rises above the base 14 by a first distance. One end of the post 21 may be rigidly connected to the anchor plate 16 and the other end of the post may be removably or detachably coupled to a portion of the shell 12 and/or the base 14. The post 21 and/or the anchor plate 16 may be spring loaded such that the anchor plate 16 may be able to be moved in a vertical direction away from the base 14 and toward a ground surface. In this instance, the entire anchor plate 16 along with the two anchors 18 and 20 can be “pulled down” away from the base 14.. In an embodiment, the anchor plate may include one or more channels 25. The anchors 18 and 20 may be partially disposed within these channels 25 and coupled to the anchor plate 16 at one or more points within the channels 25. In another embodiment, the anchors 18 and 20 may be removably coupled to the anchor plate 16. In other embodiments, the anchors 18 and 20 may be fixedly connected to the anchor plate 16 such that they are not removable by the user of the car seat 10. In an embodiment, the base 14 may include a locking or latching mechanism to hold the anchor plate 16 in place once the anchor plate 16 is placed in the desired configuration. In order to rotate the anchor plate 16, a user may need to unlock the anchor plate 16 from the base 14 and/or the car seat shell 12. This may free the anchor plate to rotate around a vertical axis that passes through the post 21. Once the anchor plate is rotated, the user may again lock the anchor plate 16 to the base 14 and/or the car seat shell 12.

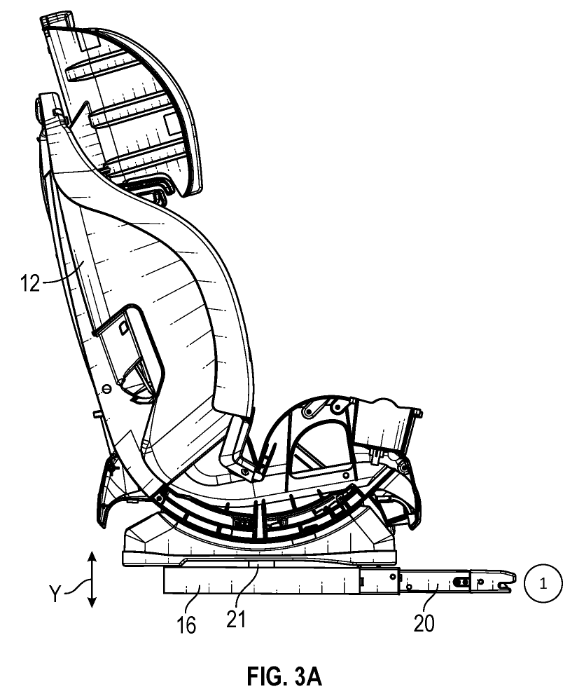

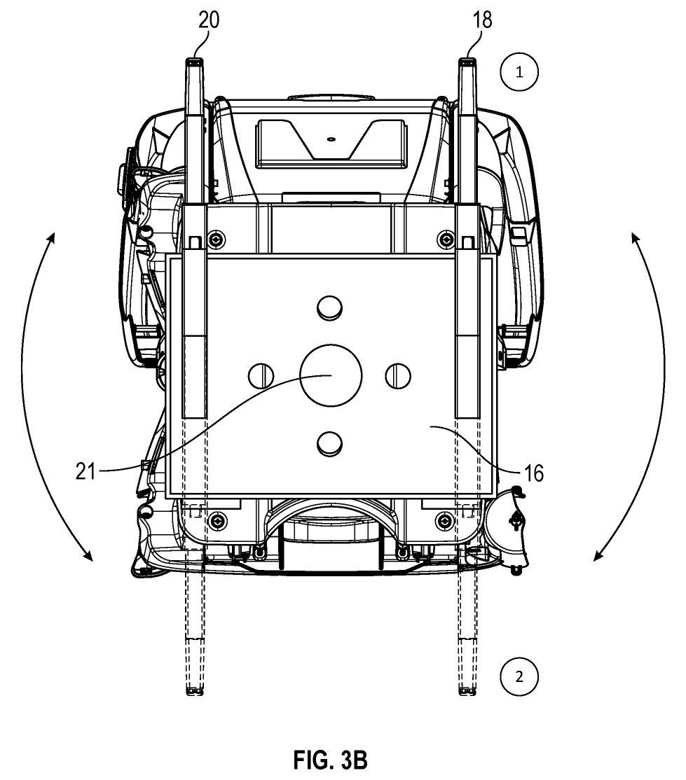

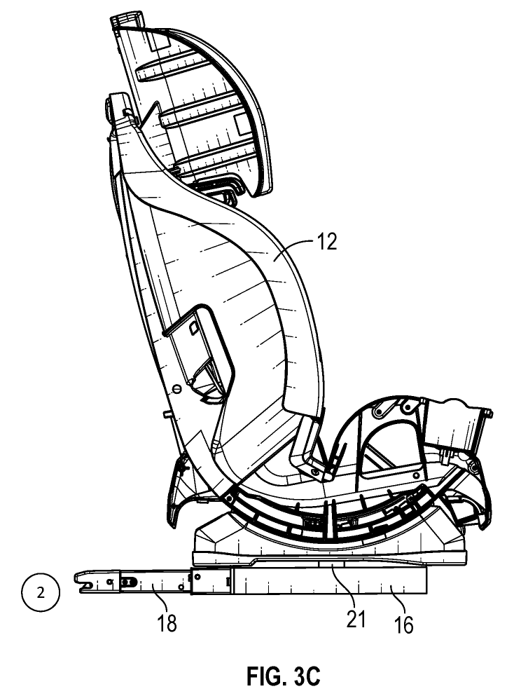

FIGS. 3A-3C illustrate the operation of the car seat 10 in accordance with the principles of the present disclosure. As explained above, the car seat 10 may be used either in a rear-facing configuration or a forward-facing configuration. FIG. 3A illustrates the car set 10 being used in a rear-facing configuration. In this configuration, the anchors 18 and 20 of the car seat 10 may be connected to the corresponding anchors of the vehicle car seat (not shown). The anchor plate 16 along with the anchors 18 and 20 is movable along the ‘Y’ or vertical axis as illustrated in FIG. 3A. In order to convert the car seat 10 from the rear-facing configuration to a forward-facing configuration, the user may unlock the anchor plate 16. Unlocking the anchor plate 16 allows the anchor plate 16 to move along the ‘Y’ axis. This may cause the anchor plate 16 along with the two anchors 18 and 20 to be temporarily decoupled from the base 14. . Once the anchor plate 16 is pulled away/decoupled from the base 14, it can be rotated 180 degrees in either a clockwise direction or an anti-clockwise direction around the vertical axis passing through the post 21, as illustrated in FIG. 3B, by applying a rotational force. Therefore, if the anchors 18 and 20 are in position ‘1’, they can be rotated to be placed in position ‘2’, as illustrated and vice versa. If position ‘1’ is considered to be a rear-facing configuration, then position ‘2’ will be the forward-facing configuration and vice versa. The decoupling of the anchor plate 16 from the base 14 allows easy rotation of the anchor plate 16 around the pivot point 23. Once the anchor plate 16 is fully rotated by 180 degrees, the anchor plate 16 may snap back into its default position by traversing along the ‘Y’ axis toward the base 14. As mentioned above, the post 21 and/or the anchor plate 16 may be spring-loaded using one or more springs (not shown) and the one or more springs are configured to bias the anchor plate 16 toward the base 14 in their default state. When the anchor plate 16 is pulled away from the base 14, these one or more springs may expand and after the anchor plate 16 is rotated to its desired position, the release of the pressure/force may cause the anchor plate 16 to move towards the base 14, as illustrated in FIG. 3C. As can be seen in FIG. 3C, the car seat 10 is now in a forward-facing configuration and the anchors 18 and 20 can be coupled to the corresponding anchors of the vehicle seat. In an embodiment, the car seat 10 may need to be decoupled from the vehicle seat in order to change the configuration of the car seat 10. In some embodiments, the anchor plate 16 can be freely rotated 360 degrees around the pivot point 23.

In embodiments where the pivot point 23 is located at the center point between the front and back of the car seat 10, the anchors 18 and 20 may be extensible and retractable along a horizontal axis to compensate for the vehicle seat bight. The vehicle seat bight is the technical term for the crack or crease where the backrest of a vehicle seat meets the bottom seat cushion. In other words, it is the corner or joint of the vehicle seat where the two parts come together. It may be sometimes also called the seat crack or seat crease. In other embodiments, the pivot point 23 may be off-center from the front to the back of the car seat 10. In this instance, the anchors 18 and 20 may not be extensible or retractable as the off-center rotation of the anchor plate 16 may compensate for some or all of the difference between the seat bight of the vehicle seat and the car seat 10. In some embodiments, the anchor plate 16 may be integrated into the base 14 such that the anchor plate 16 may reside in between a top surface and a bottom surface of the base 14. In this instance, the anchor plate 16 may be rotatable within the base 14 in both the clockwise and anti-clockwise directions. Also, in this instance, the car seat 10 can be changed from the front-facing configuration to the rear-facing configuration without detaching the car seat 10 from the vehicle seat. In some embodiments, the base 14 may have two portions, with a top portion being immovable and fixedly attached to the car seat shell 12 and a bottom portion that would constitute the anchor plate 16. Thus, in this embodiment, the base 14 and the anchor plate 16 would be part of the same structure with one portion of the structure being rotatable and the other portion of the structure being non-rotatable or fixed.

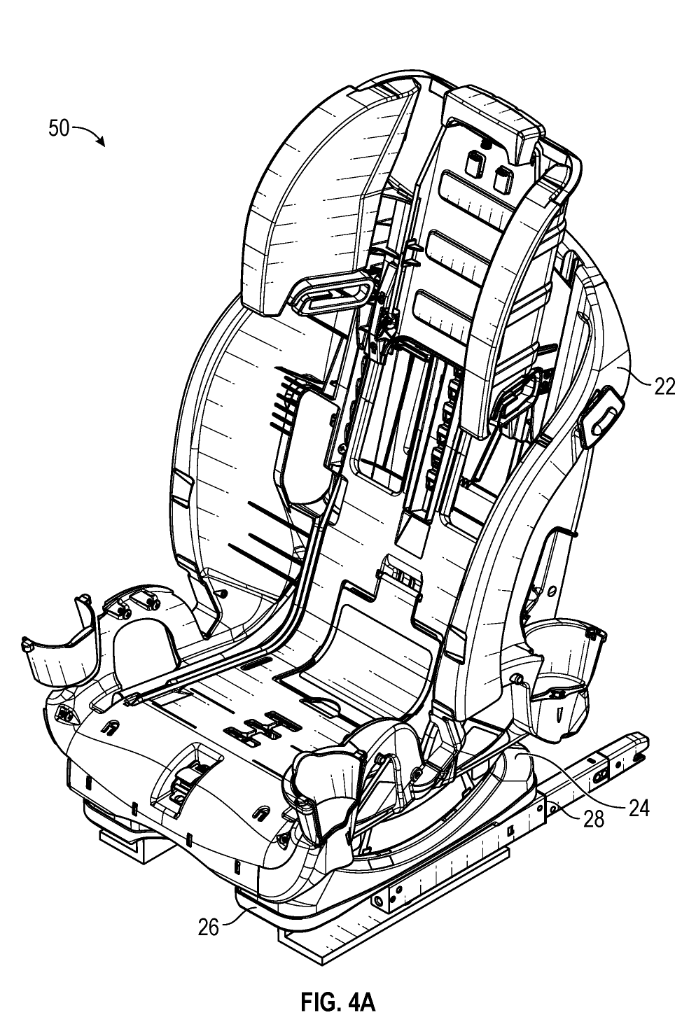

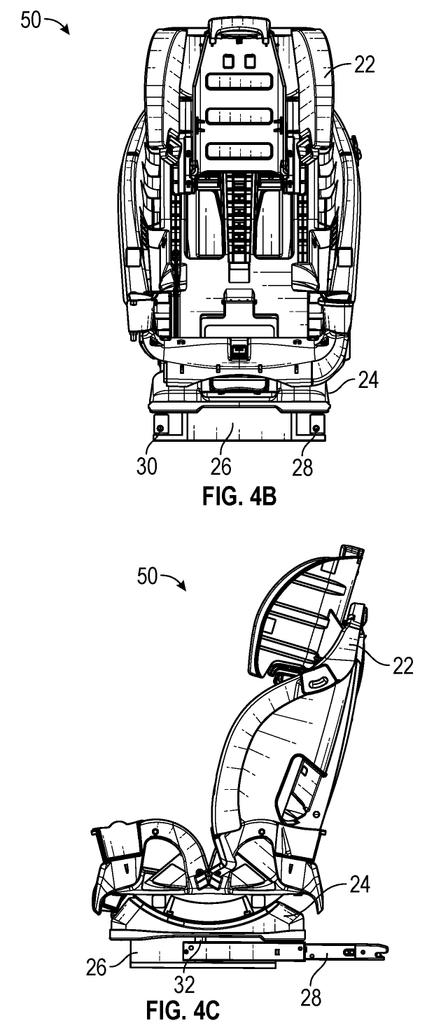

FIGS. 4A-4C illustrate various views of a car seat assembly 50 in accordance with principles of the present disclosure. The car seat assembly 50 may include a car seat shell 22 and base 24 attached to the car seat shell 22. In an embodiment, the base 24 may be removably attached to the car seat shell 22. The car seat assembly 50 may also include an anchor plate 26 coupled to the base 24. In an embodiment, the anchor plate 26 may be fixedly coupled to the base 24 such that the anchor plate 26 is not independently movable from the base 24. Two or more rigid anchors 28 and 30 may be rotatably coupled to the anchor plate 26. In an embodiment, each of the two rigid anchors 28 and 30 may be coupled to either side of the anchor plate 26, as illustrated in FIG. 4B and may be compatible with the LATCH system mentioned above. Each of the anchors 28 and 30 may be coupled to the anchor plate 26 at a respective pivot point 32 and 34. In an embodiment, the pivot points 32 and 34 may be located at a center along the depth of the anchor plate 26. In other embodiments, the pivot points 32 and 34 may be located off-center along the depth of the anchor plate 26. The anchor plate 26 may have a planar bottom surface that enable the car seat assembly 50 to be placed on the vehicle seat.

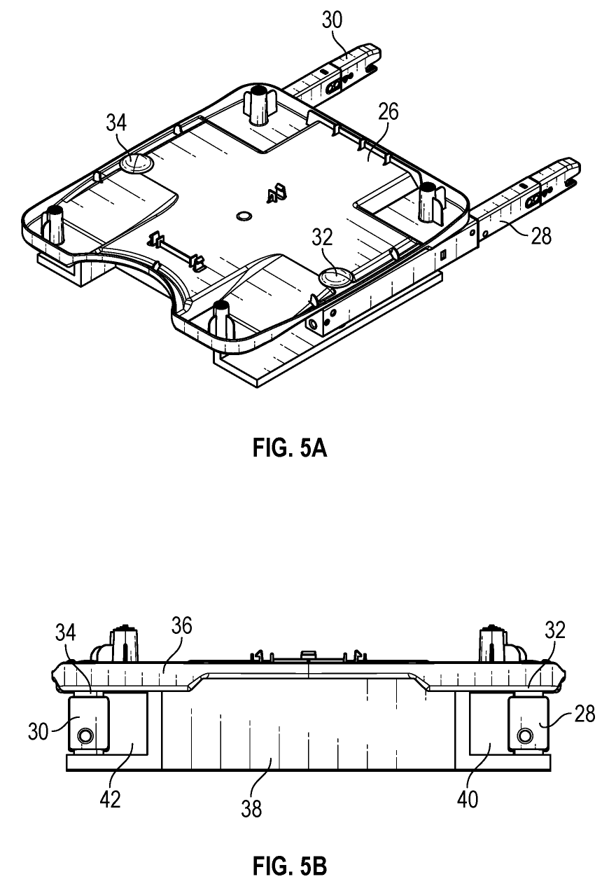

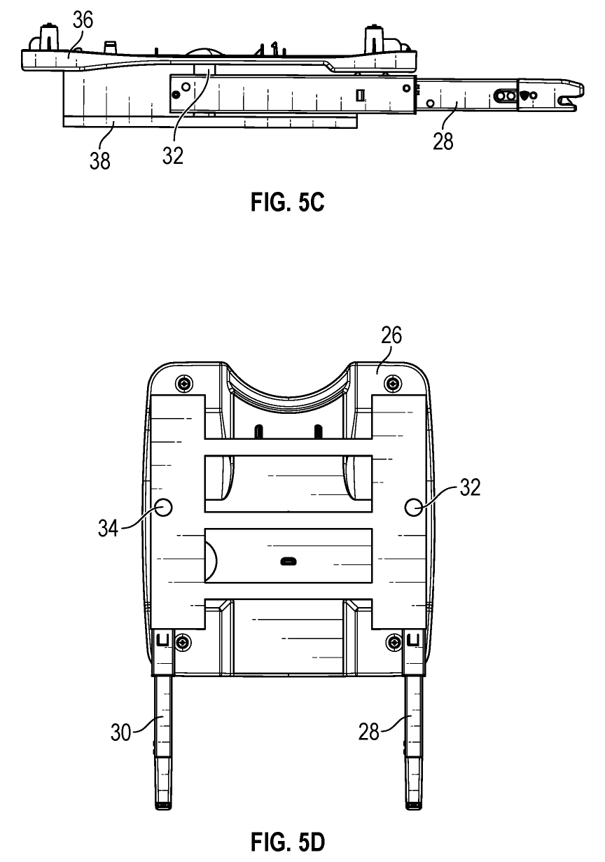

FIGS. 5A-5D illustrates the details of the anchor plate 26 and the two anchors 28 and 30 in accordance with the principles of the present disclosure. The anchor plate 26 may be generally planar in structure or otherwise shaped to complement the base 24 of the car seat assembly 50. The anchor plate 26 may include a top portion 36 that is connected to the base 24 and a bottom portion 38 at extends from the top portion 36. The bottom portion 38 may include a first channel 40 and a second channel 42 that are located at either sides of the bottom portion 38, as illustrated in FIG. 5B. The first anchor 28 may be connected between the top portion 36 and bottom portion 38 at a pivot point 32 within the channel 40. The second anchor 30 may be connected between the top portion 36 and bottom portion 38 at a pivot point 34 within the channel 42. In an embodiment, the pivot points 32 and 34 may be located at a center point along the length of the respective channels 40 and 42, as illustrated in FIG. 5C. In an embodiment, each of the anchors 28 and 30 are rotatable around their respective pivot points 32 and 34. In the embodiment where the pivot points 32 and 34 are located at or near the center of the respective channels 40 and 42, the corresponding anchors 20 and 30 may be extensible and retractable to compensate of the seat bight of the vehicle seat. In other embodiments, the pivot points 32 and 34 may be off-center from front to back along the length of the respective channels 40 and 42. In this embodiment, the off-center rotation may itself compensate for the seat bight of the vehicle seat and the anchors 20 and 30 may not be extensible and/or retractable. In some embodiments, the two rigid anchors 28 and 30 may be directly coupled to the base 24 of the car seat or may be coupled directly to the car seat shell 22. In both these instances, each anchor 28 and 30 may be coupled to the base 24 or the car seat shell 22 at a single pivot point. The single pivot point may either be located at a center along a length from the front to the back of the car seat shell 22 or the base 24. In other embodiments, the pivot point may be off-center from the front to the back of the car seat shell 22 or the base 24. The pivot points may be spring-loaded to allow the anchors 28 and 30 to freely rotated independently and lock with the base 24 or the car seat shell 22 when they are in the forward-facing configuration and the rear-facing configuration.

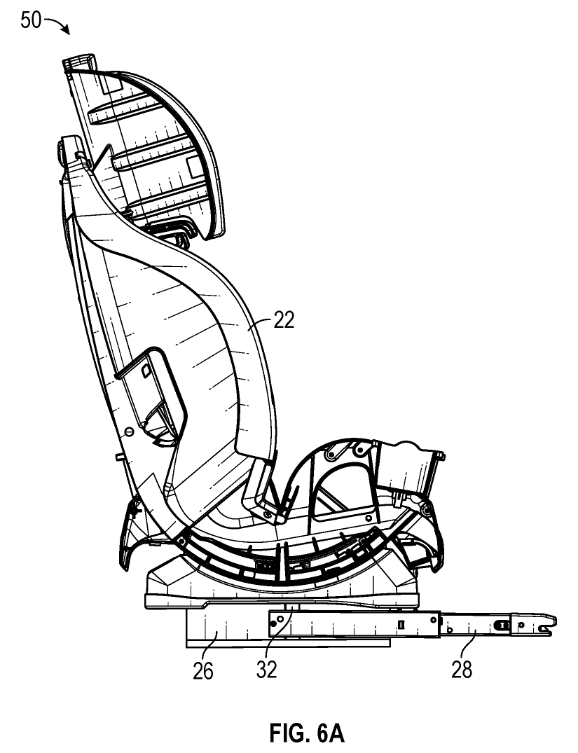

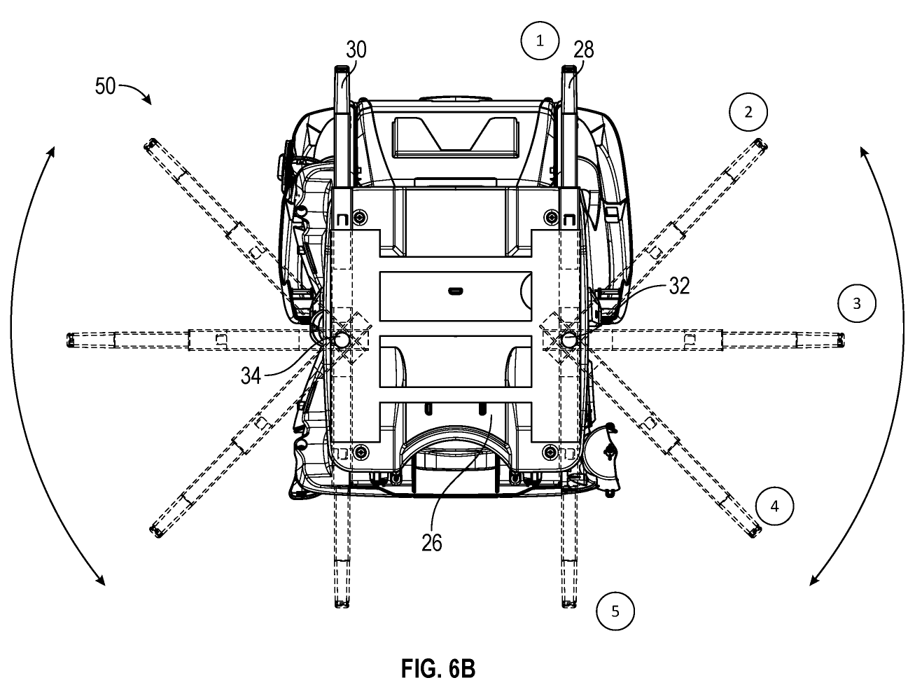

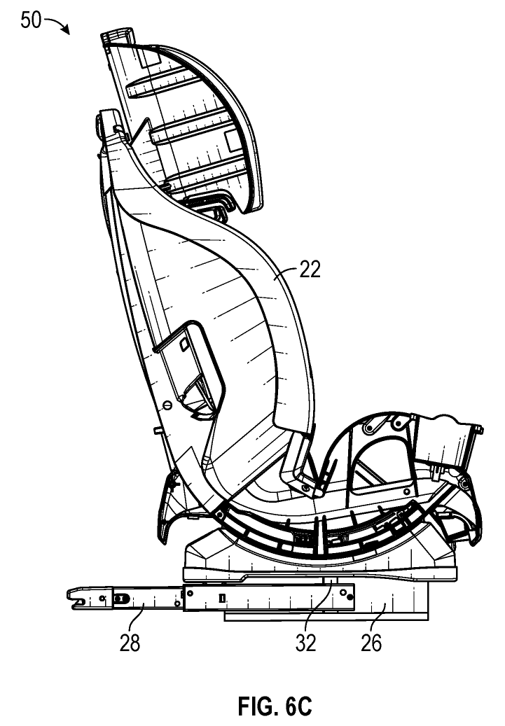

FIGS. 6A-6C illustrate the operation of the car seat assembly 50 in accordance with the principles of the present disclosure. As explained above, the car seat assembly 50 may be used in both the rear-facing configuration and the forward-facing configuration. FIG. 6A illustrates the car seat assembly 50 in a rear-facing configuration. In this configuration, the two anchors 28 and 30 are configured to be connected to the respective anchors of the vehicle seat (not shown). When a use wishes to change the configuration of the car seat assembly 50 from the rear-facing configuration to the forward-facing configuration, the user may independently rotate each of the anchors 28 and 30 from position ‘1’ to position ‘5’, as illustrated in FIG. 6B. Each of the anchors 28 and 30 is independently rotatable around its respective pivot point in either the clockwise or the anti-clockwise direction from position ‘1’ to position ‘5’ or vice versa. Thus, when the anchors 28 and 30 are rotated from position ‘1’ to position ‘5’, the car seat assembly 50 may be placed in the forward-facing configuration, as illustrated in FIG. 6C. In FIG. 6C, the anchors 28 and 30 can now be coupled to the respective vehicle seat anchors to secure the car seat assembly 50 to the vehicle seat in a forward-facing configuration. The anchor plate 26 may include a locking mechanism that may lock the anchors 28 and 30 in place when they are in position ‘1’ and/or in position ‘5’ so as to ensure that they do not move once they are coupled to the vehicle seat. In other embodiments, the each of the anchors 28 and 30 may rotate together in synchronization such that rotating one of the anchors 28 or 30 will automatically rotate the other anchor. In this embodiment, when the anchor 28 is rotated from position ‘1’ to position ‘5’ in a clockwise direction, the other anchor 30 may rotate in an anticlockwise direction from the position ‘1’ to the position ‘5’. In order to enable the two anchors 28 and 30 to rotate together in synchronization, they may be physically coupled to each other to enable the synchronized rotation.

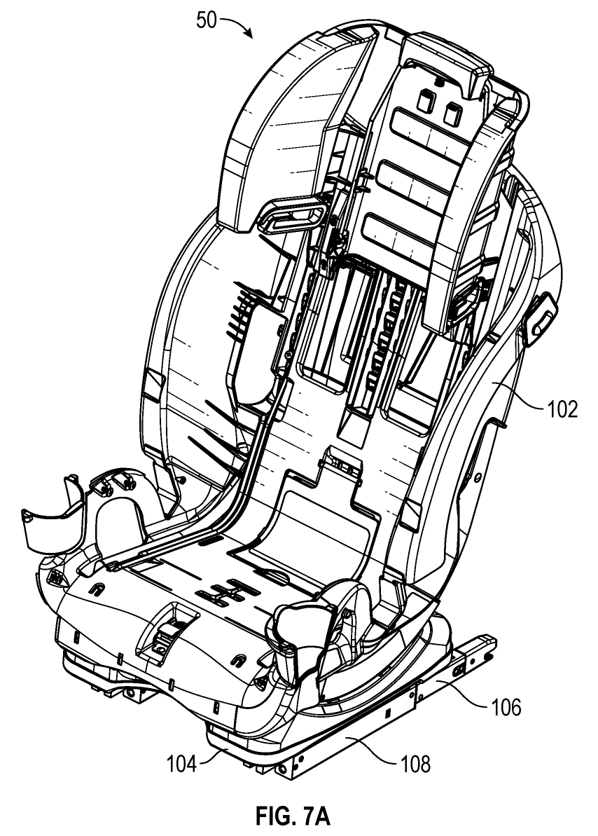

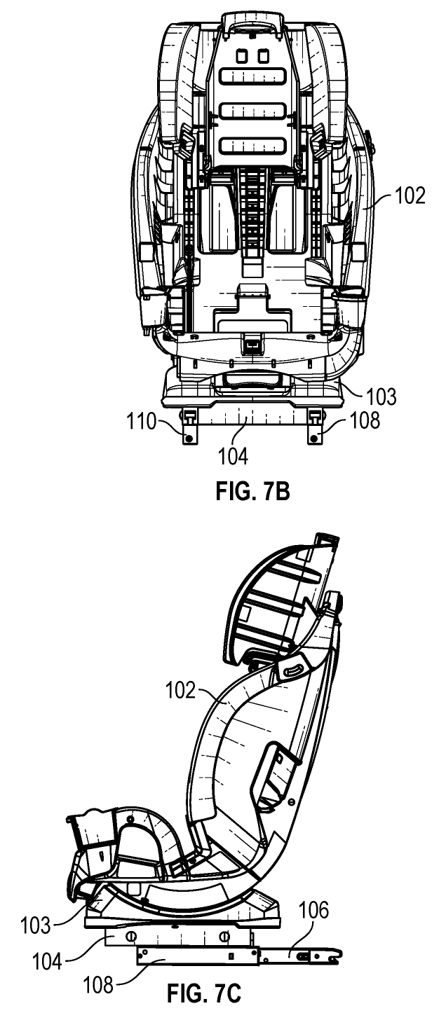

FIGS. 7A-7C illustrate various views of yet another car seat assembly 100 in accordance with the principles of the present disclosure. The car seat assembly 100 may include a car seat shell 102 and a car seat base 103 fixedly coupled to the car seat shell 102. The car seat shell 102 and the car seat base 103 may be manufactured using similar materials as that described in relation to the car seat assembly 10 above. The car seat assembly 100 may further include an anchor base 104 coupled to the car seat base 103. The anchor base 104 may be manufactured using any of the materials approved in the industry. One or more anchor assemblies may be coupled to the anchor base 104. In an embodiment, each anchor assembly may include a first portion and a second portion. For example, only a single anchor assembly is shown in FIG. 7A. That anchor assembly has a first portion 108 and a second portion 106. Similarly, the other anchor assembly (not shown) may have a third portion corresponding to the first portion 108 and a fourth portion corresponding to the second portion 106. The second portion 106 may include a rigid-LATCH anchor that may couple to a corresponding anchor of a vehicle seat. In an embodiment, the second portion 106 may be removably coupled to the first portion 108.

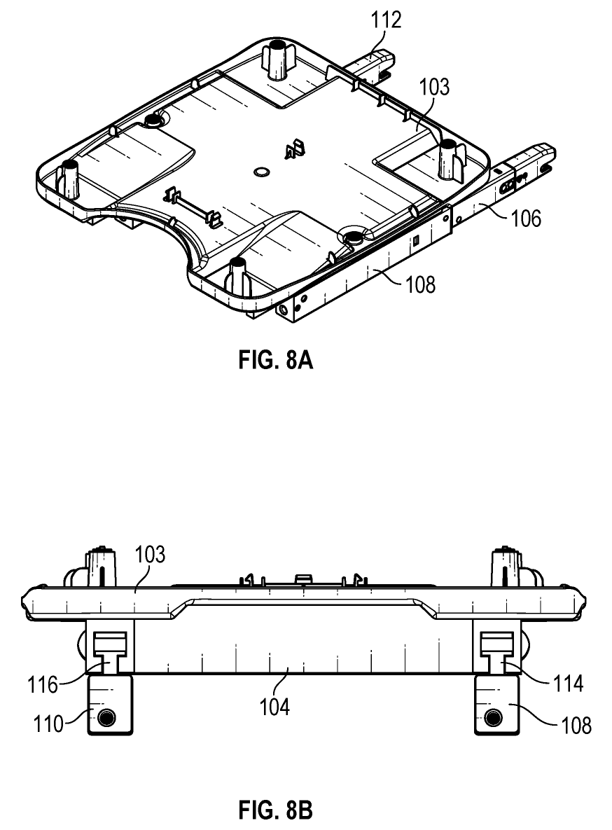

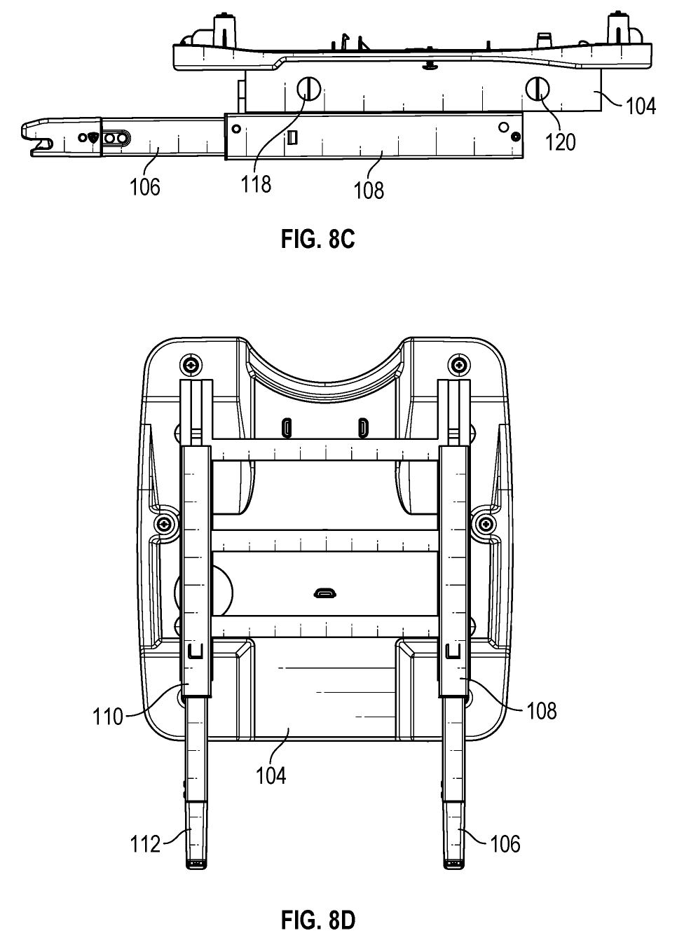

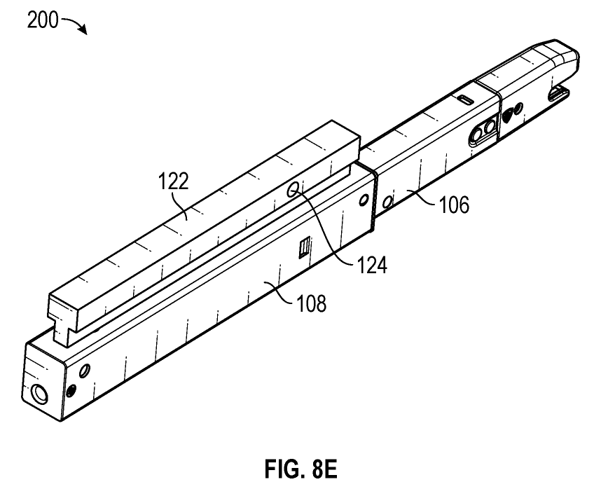

FIGS. 8A-8D illustrates various views of the car seat base 103 and the anchor base 104 sub-assembly in accordance with the principles of the present disclosure. The car seat base 103 may be planar and may have a rectangular shape. In other embodiments, the car seat base 103 may have another shape based on the design of the car seat assembly 100. The anchor base 104 may include two channels or rails 114 and 116 located on either side of the anchor base 104. The two channels or rails 114 and 116 may run from a front of the anchor base 104 to the back of the anchor base 104. The sub-assembly may further include two anchor assemblies. The first anchor assembly may include the first portion 108 and the second portion 106. The second anchor assembly may include a third portion 110 and a fourth portion 112. In an embodiment, the first portion 108 may be identical to the third portion 110 and the second portion 106 may be identical to the fourth portion 112. When the anchor assemblies are coupled to the anchor base 104, a portion of the first anchor assembly is disposed within the channel/rail 114 and a portion of the second anchor assembly is disposed within the channel/rail 116, as illustrated in FIG. 8B. The first portion 108 of the first anchor assembly may be secured to the anchor base 104 at one or more locking points 118 and 120. The locking may be achieved by use of a removable bolt that may installed across the channel/rail 114 to secure a part of the first portion 108 within the channel 114. The third portion 110 of the second anchor assembly may be coupled to the other channel/rail 116 in a similar manner.

FIG. 8E illustrates a single anchor assembly 200 in accordance with the principles of the present disclosure. Only a single anchor assembly 200 is described herein, but one skilled in the art will realize that the second anchor assembly may have an identical structure as the anchor assembly 200. The anchor assembly 200 may include the first portion 108 and the second portion 106. The anchor assembly 200 may further include a rail insert 122 mounted on top of the first portion 108. The rail insert 122 may be shaped so as to complement the shape of the channels/rails 114 and 116. In some embodiments, the rail insert 122 may be fixedly attached to the first portion 108. The rail insert 122 may include a locking pin hole 124. The locking pin hole 124 may be used to secure the anchor assembly 200 to the anchor base 104. In order to secure the anchor assembly 200 to the anchor base 104, the rail insert 122 of the anchor assembly 200 is inserted into the channel 114. The locking pin hole 124 may then be aligned with either the locking point 118 or the locking point 120. Thereafter a fastener, such as a bolt, may be inserted into the locking point 118/120 and through the locking pin hole 124 to secure the anchor assembly 200 to the anchor base 104. In an embodiment, based on whether the car seat assembly is being used in the rear-facing configuration or the front-facing configuration, either the locking point 118 or the locking point 120 of the anchor base 104 is aligned with the locking pin hole 124 of the anchor assembly 200. In some embodiments, the second portion 106 of the anchor assembly 200 may be detachable from the first portion 108. In other embodiments, the second portion 106 may be extendable from and retractable into the first portion 108. In this manner, the length of the anchors can be adjusted based on the depth of the vehicle seat.

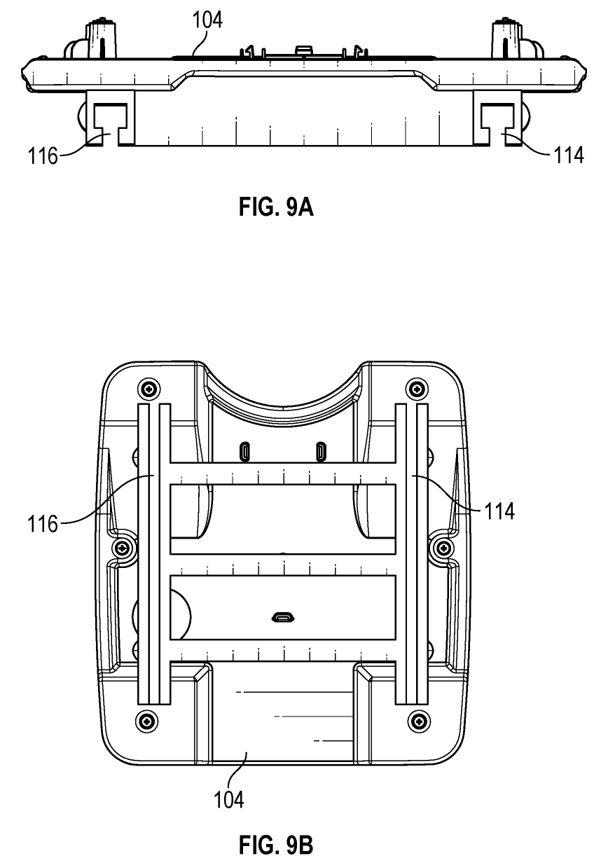

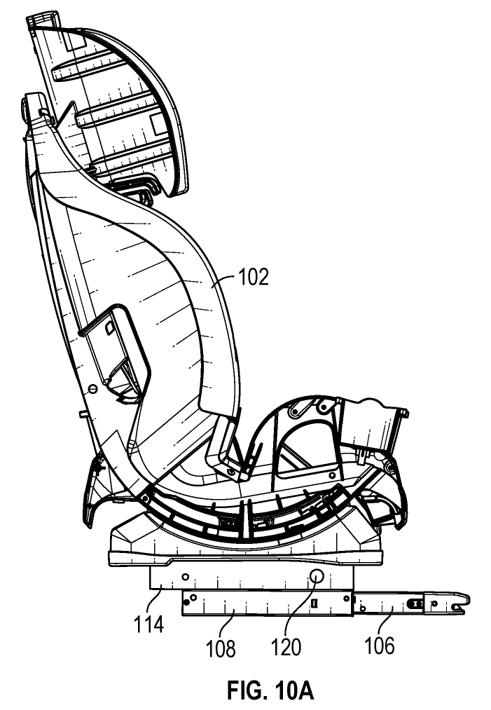

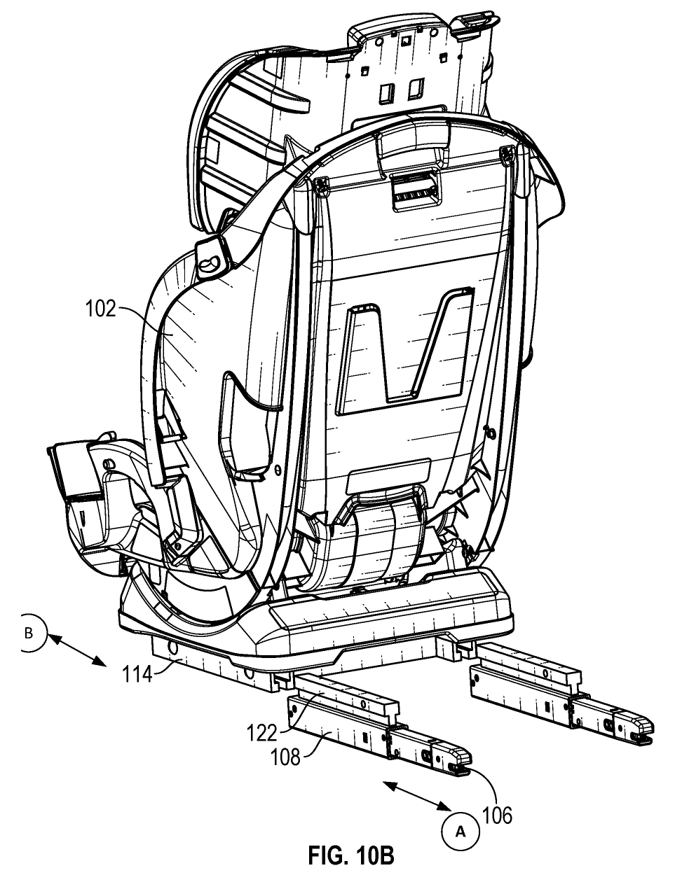

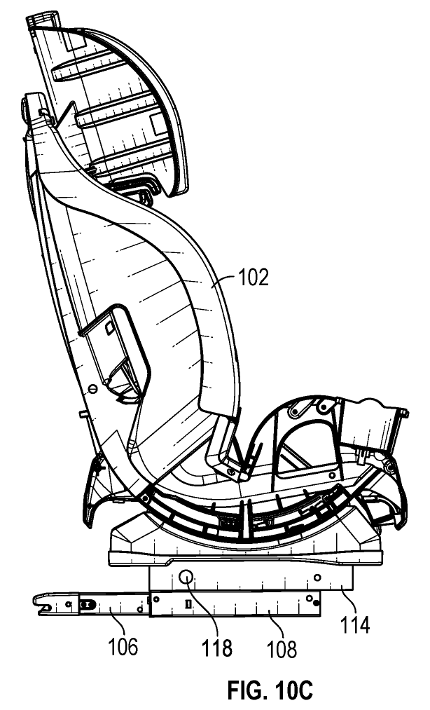

FIGS. 9A and 9B illustrate the front view and bottom view of the anchor base 104 in accordance with the principles of the present disclosure. In some embodiments, the two channels/rails 114 and 116 may be part of a single structure that is disposed on the bottom of the anchor base 104. In other embodiments, each of the channels 114 and 116 may be part of separate components that are attached to a bottom surface of the anchor base 104. FIGS. 10A-10C illustrate the operation of the car seat assembly 100 in accordance with the principles of the present disclosure. As explained above, the car seat assembly 100 may be used in the rear-facing configuration or the forward-facing configuration. FIG. 10A illustrates the car seat assembly 100 being configured in the rear-facing configuration. In this configuration, the second portion 106 of the anchor assembly can be coupled to a corresponding anchor of the vehicle seat. The rail insert 122 of the first portion 108 of the anchor assembly may be inserted into the rail 114 of the anchor base 104. In this configuration, the first portion 108 of the anchor assembly is secured to the anchor base 104 via one of the locking points 120. In other words, in this configuration, the locking pin hole 124 of the rail insert 122 is aligned with the locking point 120 of the channel/rail 114 and a fastener may be inserted into the locking point 120 and the locking pin hole 124. The second anchor assembly may be similarly connected to the anchor base 104 via the second channel/rail 116.

When the user wants to change from the rear-facing configuration to the forward-facing configuration, the user may remove the fastener from the locking point 120 and detach the anchor assembly from the anchor base 104 by sliding out the rail insert 122 from the rail 114 in the direction ‘A’ as illustrated in FIG. 10B. The user may then slide-in the rail insert 122 into the channel 114 from the opposite direction ‘B’ and align the locking pin hole 124 with the other locking point 118. The fastener may then be inserted into the locking point 118 and via the locking pin hole 124 to secure the anchor assembly to the anchor base 104. A similar operation may be performed to reorient the other anchor assembly and secure the other anchor assembly to the anchor base 104. Once this is complete, the car seat assembly 100 is now configured in a forward-facing configuration as illustrated in FIG. 10C. For changing from the forward-facing configuration to the rear-facing configuration, the same process as above may be followed in the reverse order. Thus, the car seat assembly 100 can be easily switched between the rear-facing and the forward-facing configurations with ease and with minimal user efforts. In an embodiment, each anchor assembly 200 may be coupled with anchor base via a tether (not shown). Thus, when the anchor assembly 200 is removed from the respective channel 116 or 114 during the change in the configuration of the car seat, the anchor assembly 200 is still physically connected to the anchor base 104. This ensures that the anchor assembly 200 is never fully separable from the anchor base 104. In an embodiment, the tether may be long enough to allow positioning of the anchor assemblies 200 in their respective channels.

In another embodiment, the anchor base 104 may have a single channel instead of a plurality of channels 114 and 116. The single channel may be located at the center of the anchor base 104 and extend along the length of the anchor base from the front of the anchor base 104 to the back of the anchor base. In an embodiment, two anchors may share the single channel. In this instance, the anchor assembly 200 may be formed in a ‘Y’ shape in which the rail insert 122 forms the common arm of the ‘Y’ and two anchor portions 106 and 112 may form the two arms of the ‘Y’ shape. Thus, in this embodiment, the two anchors 106 and 112 share a common rail insert 122 and thus only a single rail may be needed on the anchor base 104. In this embodiment, the anchor assembly 200 may be inserted from a first end of the single channel in the anchor base 104 to place the car seat in the forward-facing configuration and the anchor assembly 200 may be removed from the single channel and inserted from a second opposing end of the single channel to place the car seat in the rear-facing configuration.

In some embodiments, each of the anchor assemblies 200 may be independently removable and couplable to the anchor base 104. In other embodiments, both the anchor assemblies may be part of a single structure and may have to be removed and/or coupled together to the anchor base 104. In some embodiments, the rails 114 and 116 may be open or enclosed like a square tube. In some embodiments, the two anchor assemblies may be mounted to a feature that is symmetrically left to right at located at either sides of the car seat shell 12, 22, or 102. In this embodiment, the anchors may be configured to rotate about a horizontal axis. In this embodiment, the anchors may be able to rotate 180 degrees or slightly more than 180 degrees to account for the recline of the car seat assembly. The axis of rotation for the anchors may run left to right across the bottom of the car seat assembly. In some embodiments, the rotation axis may be centered front to back while in other embodiments, the rotation axis may not be centered from the front to the back. In the embodiment where the rotation axis is centered from the front to the back, the anchors may be extensible and retractable to compensate for the seat bight of the vehicle seat. In the embodiment where the rotation axis is off-center, the anchors may not be extensible or retractable as the off-center rotation may compensate for the seat bight of the vehicle seat. The anchors may be located toward the bottom of the car seat shell or the base and may lock against the bottom of the base when the anchors are in use. In other embodiments, the anchors may be mounted on a tube or similar structure that is wider than the base of the car seat assembly and that extends in a horizontal direction through the base of the car seat assembly.

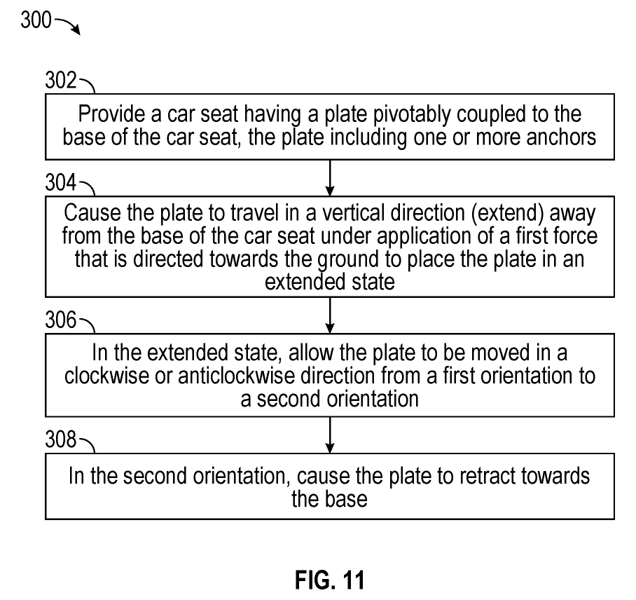

FIG. 11 illustrates a flow chart of a process 300 for using a car seat in accordance with the principles of the present disclosure. The process 300 may begin with the step 302 in which a car seat assembly is provided. This car seat assembly may include a plate pivotable coupled to the base of the car seat assembly. This plate may also include one or more anchors. In the default state, the plate may be present in a first orientation. At step 304, a first force in a downward direction toward ground may be applied to the plate. This may cause the plate to move away from the base of the car seat assembly by a first distance and cause the plate to be placed in an extended position/state. At step 306, when the plate is in the extended state, a second force may be applied to the plate in a clockwise or counter-clockwise direction to place the plate in a second orientation, while the first force is still being applied. In an embodiment, the second orientation may be 180 degrees from the first orientation. At step 308, the first force may be released or may be ceased to be applied. This may cause the plate to retract or move toward the base and couple to the base in the second orientation.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure.

While the present disclosure has been described with reference to a number of embodiments, it will be understood by those skilled in the art that the invention is not limited to such disclosed embodiments. Rather, the disclosure can be modified to incorporate any number of variations, alterations, substitutions, or equivalent arrangements not described herein, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description but is only limited by the scope of the appended claims.

What is claimed is:

1. A car seat comprising:
a car seat shell;
a base attached to the car seat shell; and
an anchor member coupled to the base, wherein the anchor member includes one or more anchors and wherein the anchor member is:
configured to rotate in response to application of a first force; and
decouplable from the base.

2. The car seat of claim 1, further comprising a locking mechanism that couples the anchor member to the base or the car seat shell.

3. The car seat of claim 1, wherein the anchor member is further configured to rotate in a clockwise or in an anti-clockwise direction.

4. The car seat of claim 3, wherein the anchor member is further configured to rotate between 180 degrees and 360 degrees.

5. The car seat of claim 1, wherein the one or more anchors are configured to rotate along with the anchor member.

6. The car seat of claim 1, wherein the one or more anchors are detachably coupled to the anchor member.

7. The car seat of claim 1, wherein the one or more anchors include rigid-LATCH anchors.

8. The car seat of claim 1, wherein the anchor member is configured to rotate around a single pivot point.

9. The car seat of claim 1, wherein the anchor member is further configured to:
be placed in an extended state; and
rotate when placed in the extended state.

10. A car seat system comprising:
a car seat shell;
a base coupled to the car seat shell;
an anchor member coupled to the base; and
one or more anchors coupled to the base, wherein each of the one or more anchors is independently rotatable around an axis and wherein the one or more anchors are configurable to place the car seat system in a rear-facing configuration or a forward-facing configuration.

11. The car seat system of claim 10, wherein the one or more anchors includes a first anchor and a second anchor and wherein the first anchor is configured to rotate around a first vertical axis and the second anchor is configured to rotate around a second vertical axis that is different from the first vertical axis.

12. The car seat system of claim 10, wherein the anchor member includes one or more channels and wherein the one or more anchors are coupled to a respective channel of the one or more channels.

13. The car seat system of claim 12, wherein each of the one or more anchors resides partially within a corresponding channel of the one or more channels.

14. The car seat system of claim 10, wherein each of the one or more anchors is rotatable by at least 180 degrees.

15. The car seat system of claim 10, wherein each of the one or more anchors is coupled to the base at a single pivot point.

16. A car seat system comprising:
a car seat shell;
an anchor base coupled to the car seat shell, wherein the anchor base includes one or more channels; and
one or more anchor members removably coupled to the anchor base, wherein each of the one or more anchor members includes a rail insert configured to mate with a channel of the one or more channels.

17. The car seat system of claim 16, wherein the rail insert is configurable to be inserted into a corresponding channel, of the one or more channels, from one of: a first direction or an opposing second direction.

18. The car seat system of claim 16, further comprising a tether attached to each of the one or more anchor members, the tether configured to keep the one or more anchor members physically coupled to the anchor base at all times.

19. The car seat system of claim 16, wherein a portion of each of the one or more anchor members is extensible and retractable.

20. The car seat system of claim 16, wherein a first anchor member of the one or more anchor members includes a first connection point and a second connection point and wherein:
when the car seat system is in the rear-facing configuration, the first anchor is coupled to a first channel of the one or more channels, via the first connection point; and
when the car seat system is in the forward-facing configuration, the first anchor member is coupled to the first channel via the second connection point.
